(19) United States
(12) Patent Application Publication
(10) Pub. No.: US 2013/0007224 A1
(43) Pub. Date: Jan. 3, 2013

(54) Lightweight Method for Out-Of-Band Management of a Remote Computer with a Mirror of Remote Software Resources

(76) Inventor: Yuanjie Yang, Shanghai (CN)

(21) Appl. No.: 13/523,871

(22) Filed: Jun. 14, 2012

Related U.S. Application Data
(60) Provisional application No. 61/503,583, filed on Jun. 30, 2011.

(51) Int. Cl. G06F 15/16

(52) U.S. Cl. 709/219; 709/217

(57) ABSTRACT

The present invention provides a technical solution for an easy, highly reliable and secure out-of-band management of a remote computer with low cost of facilities. The present invention comprises a webcam which is used as a lightweight video sniffer, an emulator of keyboard and mouse, a mirror of remote disk which contains software resources and writable data file, a mirrored agent which runs on the computer which will be controlled remotely and render output of captured screen shot, and an assistant device which connects to a remote console and bridges an out-of-band management for the controlled computer. In the present invention, the controlled computer can be diagnosed remotely by a keyboard or a mouse with a mirror of remote software resources when the computer suffers from various kinds of problem, even when the whole Local Area Network (LAN) where the computer resides in is isolated from the remote console.

### CROSS-REFERENCE TO RELATED APPLICATION

This application claims the benefit of U.S. Provisional Application No. 61/503,583; filed data: Jun. 30, 2008; title: “A Lightweight Method for Out-Of-Band Management of a Remote Computer with a Mirror of Remote Software Resources”; First Named Inventor/Applicant Name: Yuanjie Yang.

### FIELDS OF THE INVENTION

The present invention is related to an applicable and competitive technical solution of out-of-band management of a remote computer, being both of easy to use and set up, highly reliable, and secure with low cost of facilities.

### BACKGROUND OF THE INVENTION

Remote computer assistance is much easier and efficient for customers. However, remote computer assistance does not work when the computer which will be controlled remotely is in
Unresponsive states;
Absence of Operation System (OS) or crashed OS because of hardware or software failure;
BIOS setting phase;
Mal-configuration of network, mal-configuration of remote assistance service, or blocking of firewall Out-of-band management of a remote computer is gradually becoming one of the mainstream Information Technology (IT) management technologies. Known technologies and products for out-of-band management of a remote computer include:

Keyboard, video and mouse (KVM) extension over IP: KVM extension over IP redirects local keyboard, mouse and video data to a remote administration console via the Internet. A remote admin can securely gain BIOS level access to systems for maintenance, support, or failure recovery over the Internet.

However, KVM over IP switch is expensive and difficult to set up. Several physical links, including VGA cable, RJ45 cable and cables for keyboard and mouse, are connected to KVM over IP switch. Besides, a DVI to VGA convertor need to be employed if there is only a DVI port on the video card of the computer, and, there are two types of DVI connectors, DVI-Digital and DVI-Integrated, and sometimes they are in-compatible. As a result, it is really difficult to install a KVM over IP switch for a person without much knowledge in IT area.

Employing KVM over IP switch for every computer device in IT environment in advance is a way to call remote assistance with out-of-band management immediately without the effort of installing the facilities. However, it brings not only the rising cost, but also the clutter and bulk when there are several physical links to KVM over IP switch on every computer devices. As a result, KVM over IP is usually equipped on server for remote server management, seldom equipped on client computers including desktop, laptop, dock station, etc. for remote, out-of-band management

Products which integrate Intel VPro with KVM remote control are similar. Many prerequisites are necessary including BIOS setting, local server setting, etc., see http://www.altiris.com/upload/oob_impl_gde.pdf. It is uneconomic to set up and maintain all of the prerequisites for every device for long time to cater the requirements of out-of-band management, which might only happen rarely in a small portion of the devices within IT environment.

Besides, the products for providing out-of-band management of a remote computer based on both KVM extension over IP and Intel VPro with KVM remote control have limitations: 1. Computer will be controlled cannot be reached when the Local Area Network (LAN) where the computer resides in is isolated from remote assistance service provider, because of the breakdown of network device, i.e., switch, router, etc., or Internet Service Provider (ISP) server down; 2. Even IT engineer can operate the computer which is controlled remotely by keyboard or mouse with redirected video output, the IT engineer still cannot find the root cause of the problem or recover the computer by bare hands if no tools/packages are available to diagnose and recover the damaged files on the computer with breakdown of network.

In some remote assistance products, the computer which will be controlled remotely is reached by Windows Remote Desktop or Virtual Network Computing (VNC) remotely through a specific network port. To make the computer is reachable by a remote IT engineer, the network firewall, if there is one, needs to be specially configured, or by-passed by setting up another physical internet connection by a USB 3G dongle or modem dialing-up. And, there are risks of being infected by virus or Trojans for the computer in remote assistance session. Obviously, there is a requirement of system, method, apparatus and computer program product for providing out-of-band management of a remote computer with both of below features

1. Highly reliable
The computer which needs remote assistance shall always be accessible remotely by keyboard or mouse with redirected video without any assumption of type of hardware, health of hard disk and Operation System (OS), system boot phase, or network accessibility of the computer.
The computer which needs remote assistance shall always be accessible remotely by keyboard or mouse with redirected video even when the whole Local Area Network (LAN) where the computer resides in is isolated from remote service provider because of the breakdown of network device, i.e. switch, router, etc., or Internet Service Provider (ISP) server down.
Diagnostic tools, drivers, installation image of an OS, or a bootable rescue image on remote service provider side shall be always available to the computer which needs remote assistance without any assumption of type of hardware, health of hard disk, health of Operation System (OS), integration of local file system and network accessibility of the computer.

2. Easy to use and set up
One of local personnel with very few computer knowledge can set up the facilities of the remote, out-of-band management with very little time and effort;
Remote IT engineer can operate the controlled computer by keyboard and mouse directly, just like being setting in front of the computer physically.
No need to change the network or firewall configuration to allow remote assistance temporarily or permanently;

3. Low cost of facilities. At least, the facilities for remote assistance should not be as expensive as travel fee for on-site assistance during, for example, one year's service, or hiring a local IT engineer.

4. Secure. No risks of virus, backdoor, Trojans or any other nasty stuff on Internet should be brought during the session of remote assistance.

Nowadays, hardware of a computer becomes less and less expensive. As a result, more and more persons have more than one computing device at home or in office. For example, a person may have a smart phone and a laptop in hand; a desktop in office and a media sever at home at the same time.

In this invention, a computing device which is not occupied is leveraged as an assistant device to bridge an out-of-band management for another computer which suffers hardware or software problem; a USB device emulates remote keyboard & mouse input and mirrors remote software utilities; a webcam is employed as a lightweight way to capture the screen image of the computer which will be controlled remotely; the quality of captured screen by webcam is poor, but is enough to trigger another agent which is mirrored by USB device; The agent captures the screen of the controlled computer programmably and renders the screen data to remote console.

United States Patent Application 20080088440, Wireless remote assistance, presents a general method for remote assistance with wireless communication. Comparably, the present invention is more specific and only relates to remote, out-of-band management of a computer with remote keyboard and mouse control and a mirror of remote software resources. United States Patent Application 20100238194, Methods And Apparatuses For Using A Mobile Device To Provide Remote Assistance, present another general method for remote assistance by using a mobile device. Comparably, the present invention is more specific for out-of-band management for a computer. In the exemplary embodiment of present invention, audio instruction which is sent to one of local personnel is only to input password of local account by local keyboard, running agent to render the screen image, etc.

United States Patent Application 20090080023, Remote access apparatus and remote access system, presents a method for a plurality of image processing apparatuses. Comparably, the exemplary embodiments of present invention are applicable technical solutions only for remote compute assistance with out-of-band computer management.

### SUMMARY OF THE INVENTION

System, method, apparatus and computer program product for providing a lightweight Out-Of-Band management of a remote computer with a mirror of remote software resources is disclosed. In this system, method, apparatus and computer program product, the user can request remote, out-of-band management of a computer easily, highly reliably and securely with very low cost of facilities. The apparatus comprises a keyboard and mouse emulator, a local mirror of software resources at assistance service provider side, a local mirrored agent to capture screen programmably, an assistant device, a remote console runs remotely at assistance service provider side, and a webcam which is an optional device for less local involvement. The apparatus comprises steps of:

1. Getting videos of controlled computer by webcam
the webcam attached to an assistant device is placed in front of the display screen of the computer which needs remote assistance;
the assistant device controls the webcam, read images captured by the webcam and transmits the image to the remote console via network;
the remote console receives the image, and display the image on a graphic user interface to a remote IT engineer;
the quality of the screen image captured by webcam is poor, but is enough to a remote IT engineer to trigger an locally mirrored agent for good quality of screen image capture. Actually, the screen image captured by webcam is only used to start the agent to capture screen programmably when there is execution environment.

2. Getting videos of controlled computer programmably by locally mirrored agent
the agent is triggered by a remote IT engineer, or by a local assistant if there is a health system on the controlled computer, otherwise, the agent is triggered in safe mode, WinPE, or other pre-OS environment;
the agent capture screen image, write the image data to the USB storage mirror, the data is redirected to remote console in a write operation as mentioned in No. 4. “Mirroring the disk on assistance service provider side to local USB mass storage”
the remote console monitors the image data written by agent, and display the image on a graphic user interface to a remote IT engineer once the end tag is found;
the quality of the screen image captured programmably is good. However, more local involvement is needed to start the agent if no webcam is employed and the controlled computer reboots, or boots to safe mode or a clean pre-OS environment during an out-of-band management session.

3. Sending remote keyboard or mouse input to controlled computer
the remote IT engineer operates the graphic user interface which contains the captured image of the display screen of the controlled computer for diagnosis and recovery by keyboard and mouse;
the keyboard and mouse operations of remote IT engineer are captured and sent to the keyboard and mouse emulator, via the assistant device;
the keyboard and mouse operations are reported to the controlled computer by the keyboard and mouse emulator, as if the remote IT engineer sets on-site, in the front of the computer and operates directly;

4. Mirroring the disk on assistance service provider side to local USB mass storage
the remote IT engineer specifies a CD/DVD image file, or an area of disk on remote console side, for example, a separate drive, which contains the software utilities, like diagnostic tools, installation packages, a bootable image, and writable area;
the USB storage mirror is plugged into the computer which will be controlled remotely, describes itself as a USB CD/DVD drive, or a USB flash drive, during device enumeration;
the USB storage mirror receives the command blocks from USB host, i.e., the computer which will be controlled remotely, and redirects the command blocks to the remote console, via the assistant device;
the remote console execute the command block, read/writes the data from/to the pre-specified CD/DVD image file, or an area of disk, sends the execution result back to the USB storage mirror, via the assistant device;
the USB storage mirror returns the execution result to USB host, as if the command blocks are executed locally on a real USB mass storage device;

5. A local assistant is involved during remote control session. In one touch provision mode, all the things the local assistant needs to do is setup facilities including the webcam. In local involvement mode, the local assistant needs run the local mirrored agent in every system reboot to render video output of the controlled computer.

In the exemplary embodiment of the present invention, a standalone USB webcam is employed to capture the image of display screen of the computer which will be controlled remotely; a desktop, laptop or mobile device which is not occupied and used as the assistant device has a network interface to access to remote console over intranet or internet and bridges an out-of-band management for the computer which will be controlled remotely; a USB Human Interface Device (HID) emulator which receives remote operations of keyboard or mouse and redirects to the controlled computer; a USB storage mirror which maps to the software resources on remote console; a locally mirrored agent captures screen of controlled computer programmably; a remote console receives captured image of display screen of the computer which will be controlled remotely, displays on a graphic user interface, sends the captured input of keyboard and mouse of an IT engineer to the USB HID emulator, or data of mirror software resources, via the assistant device.

In the exemplary embodiments, the communication between the USB HID emulator/USB storage mirror and the assistant device is through short range wireless signal; the communication between assistant device and remote control is through IP network, intranet or internet. USB HID device and storage is widely supported in BIOS, pre-OS environment, Windows, etc. A newly established internet connection can be employed, if current network connectivity is un-available to access remote console. As a result, out-of-band management can be undertaken remotely with remote software resources without any assumption of hardware, software, network connectivity of the computer, and, even without the assumption of the network connectivity of the whole Local Area Network (LAN) where the computer resides in.

### BRIEF DESCRIPTION OF THE DRAWINGS

The foregoing and other features and advantages of the invention will be apparent from the following, more particular description of exemplary embodiments of the invention, as illustrated in the accompanying drawings. In the drawings, like reference numbers generally indicate identical, functionally similar, and/or structurally similar elements. A preferred exemplary embodiment is discussed below in the detailed description of the following drawings:

FIG. 1 is an illustrative block diagram of an exemplary embodiment of present invention.

FIG. 2A is a flowchart of enumeration of a USB device

FIG. 2B is a flowchart of data transfer between USB host, i.e., the controlled computer and the USB storage mirror.

FIG. 2C is a flowchart of data transfer between USB host, i.e., the controlled computer and the USB HID emulator.

FIG. 3 is a flowchart of the communication between the assistant device and the remote console in an out-of-band management of a remote computer.

### DETAILED DESCRIPTION OF EXEMPLARY EMBODIMENTS OF THE PRESENT INVENTION

A preferred embodiment of the invention is discussed below as well as various other exemplary, but non-limiting embodiments.

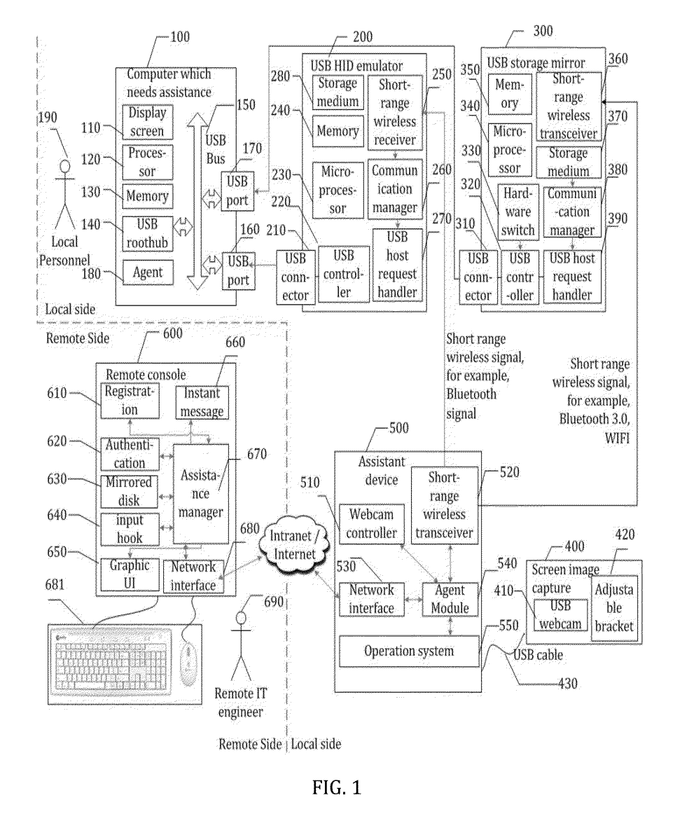

FIG. 1 depicts an illustrative block diagram of an exemplary embodiment of the present invention which comprises a controlled computer 100, a USB HID emulator 200 which is used as keyboard and mouse emulator, a USB storage mirror 300 which maps to remote software resources, a standalone USB webcam 410 with an adjustable bracket 420, a desktop, laptop, or mobile device which is used as an assistant device 500 and a remote console 600.

The controlled computer 100 is the computer which is controlled remotely, includes a display screen 110, a processor 120, a memory coupled to the processor 130, a USB roothub 140, a USB bus 150, USB port 160 and 170 and an agent 180. When the USB HID emulator 200 is connected to the USB port 160 by the USB connector 210, the USB roothub 140 will treat the USB HID emulator 200 as a standard USB keyboard or mouse. Again, when the USB storage mirror 300 is connected to another USB port 170 by the USB connector 310, the USB roothub 140 will treat the USB storage mirror 300 as a standard USB mass storage device, either a USB CD/DVD device or a USB flash device.

The sub-components 110-170 of the computer in FIG. 1 are standard configuration of a modern computer device. As a result, there is no any assumption of the type of hardware of the controlled computer 100. Even, there is no assumption of the health of the hardware component which has no relation with the sub-components 110-170, for example, a hard disk, or a CD-ROM device, etc.

The agent 180 is triggered to capture screen image programmably and write the image data to the USB storage mirror in a graphic mode of execution environment. The agent 180 is also triggered to redirect telnet to remote console side in a text mode of execution environment. In both of the mode, the data is redirected to and handled on remote console side by the USB storage mirror 300.

One of local personnel 190 is involved during remote assistance session, receives text or voice instructions on the assistant device, undertaking tasks of inputting password of local account by local keyboard, correcting the place of the webcam to capture a cognizable image of display screen of the controlled computer 100, pushing power button to start the computer 100 or to force a hard power re-cycling for the computer 100 if the computer 100 is in an un-responsive system, etc.

The USB HID emulator 200 is hardware USB device, describes itself as a USB human interface device during USB device enumeration. The USB HID emulator 200 comprises a USB connector 210, a USB controller 220, microprocessor 230, memory coupled to the microprocessor 240, a short range wireless receiver 250, procedures including communication manager 260 which handles short range wireless communication via the short range wireless receiver 250 and USB host request handler 270 and a computer-readable storage medium 280 to reserve the procedures 260-270, for example, Electrically Erasable, Programmable, Read-Only (EEPROM), or flash.

The USH HID emulator 200 is used to simulate a real keyboard or mouse to the controlled computer. The keyboard or mouse operations are received by the short range wireless receiver 250 via short range wireless signals from the assistant device 500, and then are reported to the computer 100 as a standard keyboard or mouse event.

The USB host request handler 270 handles USB communication with USB roothub 140 of the controlled computer 100, responding to the USB host requests, including GET_DESCRIPTOR, SET_ADDRESS, SET_CONFIGURATION, and SET_IDLE, during enumeration phase and IN Interrupt during data transfer phase.

In this exemplary embodiment, the type of data transfer between the controlled computer and the USB HID emulator 200 is using, but not restricted to, interrupt transfer.

Preferably, the microprocessor 230 is using MCS 51 series microprocessor, the short range wireless receiver 250 is using Bluetooth receiver, both of them are mature solutions and widely used in industry control with many vendors.

Preferably, the short range wireless receiver 250 has a unique device name shared between the USB HID emulator 200 and the assistant device 500.

The USB storage mirror 300 is a hardware USB device, describes itself as a USB mass storage device, a USB CD/DVD device or a USB flash device, during enumeration. The USB storage mirror 300 comprises a USB connector 310, a USB controller 320, a hardware switch 330, a microprocessor 340, a memory 350 coupled to the microprocessor, a short range wireless transceiver 360, procedures including communication manager 380 which handles short range wireless communication via the short range wireless transceiver 360 and USB host request handler 390 and a computer-readable storage medium 370 to reserve the procedures 380-390, for example, EEPROM, or flash.

To USB host, i.e., the controlled computer 100, the USB storage mirror 300 is a real USB mass storage device. However, the data content is not on local CD/DVD disk or flash, but mapped remotely to a specified CD/DVD image file, or a specified area of disk on remote console which contains diagnostic tools, installation packages, bootable images, or writable disk area. In this exemplary embodiment, the type of data transfer between USB host i.e. the controlled computer 100 and the USB storage mirror 300, is using, but not restricted to, bulk-only transport. In bulk-only transport, there are three types of data, Command Block Wrapper (CBW), Command Status Wrapper (CSW), and the content of data. CBW is command from USB host to the USB storage mirror 300; while CSW is report of the execution result from the USB storage mirror 300 to USB host.

When the controlled computer 100 read/write the data on the USB storage mirror 300 in a bulk-only transport, CSW is sent from the controlled computer 100 to the USB storage mirror 300. The USB storage mirror 300 parses CBW to get the command blocks within CBW, including Reduced Block Commands (RBC) which is typically used in a flash device, or SFF-8020i, MMC-2 which is typically used in a CD/DVD device, redirects the command blocks to the remote console 600 to execute via the assistant device 500, replies the data and CSW to the controlled computer 100 to report the result of the execution of the command.

The hardware switch 330 physically disconnect the USB storage mirror 300 from the controlled computer 100 in BIOS phase, to avoid the controlled computer 100 boot to the USB storage mirror while the controlled computer 100 will reboot to safe mode, actually.

The USB storage mirror 300 communicates with the assistant device 500 by short range wireless transceiver 360 via short range wireless signals.

The USB host request handler 390 handles USB communications with USB host, i.e., the controlled computer 100, including enumeration phase and data transfer phase.

Preferably, the USB storage mirror 300 can be configurable to be enumerated as either a USB CD/DVD device or a USB flash device by USB host, i.e., the controlled computer 100, by a setting on the remote console 600. If the software resources which are needed in diagnosis and recovery are contained in an International Organization for Standardization (ISO) file, the USB storage mirror 300 shall be mapped to the ISO file, as a USB CD/DVD device. If the software resources which are needed in diagnosis and recovery are contained in an area with a valid file system, for example, File Allocation Table (FAT) or FAT32, the USB storage mirror 300 shall be mapped to the area, as a USB flash device. Preferably, the setting is sent to the assistant device 500 and redirected to the USB storage mirror 300. A variable stored in memory, EEPROM, or flash in the USB storage mirror 300 is assigned to a value by the communication manager 360 upon receives the setting command. Different handler is loaded during enumeration to report the different subclass of the USB mass storage class, i.e., a CD/DVD device or a flash device, to USB host and during data transfer to handle different command blocks within CBW, according the value of the variable.

When the USB storage mirror 300 is configured to be mapped to an ISO file as a USB CD/DVD device, preferably, the ISO file is mounted to a virtual CD/DVD drive by tools of CD/DVD emulator, for example, DAEMON Tools.

Preferably, to get enough bandwidth, the microprocessor 340 is using ARM microprocessor; the short range wireless transceiver 360 is using Bluetooth 3.0 or WIFI transceiver. Both of them are mature solutions with many vendors.

Preferably, the short range wireless transceiver 360 has a unique device name shared between the USB HID emulator 300 and the assistant device 500.

Preferably, the USB storage mirror 300 is a read-write USB mass storage device. That means, not only the software resources on the remote console 600 can be accessed on the controlled computer 100, but also the screen image captured programmably or telnet on the controlled computer 100 can be redirected to the remote console 600 in an out-of-band management. Preferably, the mirrored software resources on the remote console 600 are cached on the assistant device 500, or a local flash on USB storage mirror 300 for faster access in the next time.

In this exemplary embodiment of the present invention, the USB HID emulator 200 and the USB storage mirror 300 are separated in two USB hardware device for clearly demonstration. In a real embodiment of the present invention, preferably, the USB HID emulator 200 and the USB storage mirror 300 are merged into an one USB hardware device, sharing the same micro-processor, memory, USB controllers and short range wireless transceiver by reporting to USB host two types of USB class, i.e., the USB HID and the USB mass storage, or reporting respectively behind a USB hub.

The assistant device 500 can be a desktop, laptop, or a mobile device which has access to the remote console 600. The assistant device 500 comprises a webcam controller 510, a short range wireless transceiver module 520, a network interface 530, an agent module 540, and an operation system 550.

The standalone USB webcam 410 is attached to the assistant device 500 by USB cable 430 and is installed on an adjustable bracket 420 to fit the height of display screen 110 of the controlled computer 100.

The agent module 540 comprises sub-procedures including compression and encryption module, communication manager to communicate with the USB HID emulator 200, the USB storage mirror 300 and the remote console 600, service registration request module and remote assistance request module.

The agent module 540 calls service registration request module and remote assistance request module during remote assistance service registration and request.

The agent module 540 bridges remote keyboard and mouse control with redirected video by calling the webcam controller 510 to control the USB webcam 410 to capture the display screen 110 of the controlled computer 100 at a pre-configured frequency, sending the captured image to the remote console 600 by the network interface 530, receiving programmably captured video output of controlled computer 100 by short range wireless transceiver module 520, redirecting the image to the remote console 600 by the network interface 530, receiving the remote operations of keyboard or mouse by the network interface 530, and then redirecting the operations of keyboard or mouse to the USB HID emulator 200 by the short range wireless transceiver module 520.

The agent module 540 bridges an mirror of remote pre-defined disk area by receiving command blocks from the USB storage mirror 300 the by short range wireless transceiver module 520, redirecting the command blocks to the remote console 600 by the network interface 530, receiving data and execution result from the remote console 600 by the network interface 530, and then redirecting the data to the USB storage mirror 300 by the short range wireless transceiver module 520.

When a laptop or mobile device is used as the assistant device 500, preferably, the embedded webcam on the laptop or mobile device is used to capture the image of display screen 110 of the controlled computer 100, to replace a standalone USB webcam. Preferably, a triangular easel is employed to fix the laptop or mobile device in the front of the display screen 110 of the controlled computer 100 for both scalable and stable.

Preferably, the webcam which is to capture the image of display screen 110 of the controlled computer 100, either the standalone USB webcam 410 or an embedded webcam on a laptop or a mobile device which is employed as the assistance device 500, is a digital webcam, and, to make the captured image of the display screen 110 of the controlled computer 100 cognizable, preferably, the webcam has a resolution at 1 Mega-pixel, or higher.

Preferably, the image of display screen 110 captured by webcam is only used to trigger an agent to get a more clear video output of the controlled computer 100.

Preferably, the USB webcam 410 connects to the assistant device 500 by a USB cable, or wireless USB.

Preferably, the USB webcam 410 can be integrated in the USB HID emulator 200 or the USB storage mirror 300, for easier setup of the facilities.

Preferably, the short range wireless transceiver 520 in FIG. 1 is using Bluetooth 3.0 or WIFI transceiver for broad bandwidth. WIFI transceiver is available on many laptop and mobile device, and can be employed on desktop by using a Bluetooth or WIFI USB dongle.

Preferably, the captured image is compressed and encrypted before transmission for performance and security.

Preferably, the key which is used in encryption of captured image is generated by user identification, password and varying data, for example, date, by shared algorithm between the assistant device 500 and the remote console 600.

Preferably, the image captured by webcam is displayed on GUI on agent module 540 before sent to remote console 600. With these pictures, local assistant adjusts the webcam 410 to make sure the display screen 110 of the controlled computer 100 is under the monitor of the webcam 410 completely.

Preferably, the network interface 530 is layered on a newly established connection, for example, a 3G connection by a USB 3G dongle, a proxy of 3G mobile device or an embedded 3G module on a mobile device, when the whole Local Area Network (LAN) where the controlled computer 100 resides in is isolated from the remote console 600 because of breakdown of network devices, i.e., switch, router, etc, or Internet Service Provider (ISP) server down. Preferably, the network interface 530 is layered on connections over current network resource, either wired connection to a switch or WIFI wireless connection to an Access Point (AC), etc., when current network connectivity to the remote console 600 is still available. When the network interface 530 of the assistant device 500 is layered on wired connection to the same switch, or layered on the WIFI wireless connection to the same AC, with the controlled computer 100 connects to, preferably, the agent module 540 sends a wake-on-LAN package, a wake-on-wireless-LAN package, Intel Active Management Technology (AMT) or Alert Standard Format (ASF) power management package, to the controlled computer 100 to wake up the controlled computer 100 for remote assistance, if the computer 100 is shutdown, hibernates, or stands by after the remote assistance request is posted in a waiting queue, and facilities for remote assistance is already set up.

When the network interface 530 of the assistant device 500 is layered on wired connection to the same switch, or layered on the WIFI wireless connection to the same AC, with the controlled computer 100 connects to, preferably, the agent module 540 sends Intel AMT or ASF power management package to the controlled computer 100 to force a reset if the computer stuck in un-responsive state.

Preferably, a mobile device is employed as the assistant device 500 if there is such an idle device with 3G module, to save a standalone USB 3G dongle, when a 3G connection is needed to access the remote console 600.

Preferably, a laptop or a mobile device is employed as the assistant device 500 if there is such an idle device with Bluetooth or WIFI module and webcam module, to save a standalone USB Bluetooth dongle and a standalone USB webcam 410.

When a mobile device is employed as the assistant device 500, preferably, the mobile device is a device with Mac OS or Andriod OS which has rich and friendly API for application development.

When a mobile device with Mac OS or Andriod OS is employed as the assistant device 500, preferably, the agent module 540 is installed on the mobile device from Apple's AppStore, or Google Android Application Store.

Preferably, the agent module 540 of the assistant device 500 connects the remote console 600 by port 80 or port 443.

The remote console 600 comprises a service registration module 610, a request authentication module 620, a pre-defined shared disk area 630, an input device hook module 640, a Graphic User Interface (GUI) 650, an instant message communication session manager 660, an assistance manager 670, a network interface 680, and a physical keyboard and mouse 681.

The assistance manager 670 calls service registration module 610 to assess assistance registration requests from the on-site assistant device 500.

The assistance manager 670 calls service authentication module 620 to authenticate assistance request.

In this exemplary embodiment of the present invention, authentication module 620 which authenticates assistance request is using, but not restricted to, user identification and password authentication.

When authentication passes, the assistance management 670 receives captured screen image of the controlled computer from the assistant device 500, and displays the image on the GUI 650.

The input device hook module 640 captures the keyboard and mouse events which are manually inputted by remote IT engineer 690 by the physical keyboard and mouse 681 onto the GUI 650 which displays the captured screen image of controlled computer 100 for diagnosis and recovery.

The assistance manager 670 collects the captured keyboard and mouse events associated with a specific assistance session, encodes keyboard and mouse operation and then sends the encoded data to the USB HID emulator 200 via the assistant device 500.

The assistance manager 670 executes command blocks from the USB storage mirror 300 via the assistant device 500, read/write the data in the shared disk area 630 which include software utilities and writable data files, and replying the data and execution result to the USB storage mirror 300 via the assistant device 500.

Remote IT engineer 690 is an expert with knowledge matches with description of the problem within assistance request from the assistant device 500.

Preferably, the screen image is captured, compressed and encrypted, and needs to be extracted and decrypted before display, for performance and security.

Preferably, in most of time, the screen image is captured by webcam 410 is only used to trigger the agent 180 on controlled computer 100 by remote IT engineer.

Preferably, out-of-band management for computer system diagnosis is recommended in one touch provision mode. In this mode, no local assistance is needed after setting up facilities including installing a webcam, a USB HID emulator 200, a USB storage mirror 300, placing the webcam in front of the display screen 110 of the controlled computer 100, finding an assistant device 500 and running agent module 540.

Preferably, out-of-band management for trouble shootings for application, network facilities, etc., are recommended in local involvement mode. In this mode, webcam is not installed, local assistant runs agent directly to render clear image. However, local assistance needs to run the agent again if the controlled computer 100 reboots during out-of-band management session. Preferably, the same process is ongoing on remote console side on another computer with the same hardware or software environment to compare to help to recognize the screen image captured by webcam when there is no chance to capture the screen image programmably or redirect telnet in some execution environment, for example, in BIOS setting phase and Windows installation phase.

Preferably, the screen of step by step configurations in execution environment where there is no chance to capture the screen image programmably or redirect telnet are cached on remote console by, say, VGA sniffer, for later reference when remote IT engineer works with a webcam captured video.

Preferably, the key which is used in decryption of captured image is generated by user identification, password and varying data, for example, date, by shared algorithm between the assistant device 500 and the remote console 600.

Preferably, there is a time protocol to sync the date between the remote console 600 and the assistant device 500.

Preferably, there is a mouse positioning system to compute the ratio between real resolution of display screen 110 and the window size of the graphic user interface which displays the captured screen image.

Preferably, there is a mouse positioning system to correct the ratio of the cursor of mouse between captured display screen 110 by webcam and the resolution of display screen 110. For example, the ratio is computed by clicking four corners of the quadrangle of the display screen 110 on graphic user interface 650.

Preferably, there is a pause button on the graphic user interface on the remote console 600 to pause capturing and sending from the assistant device 500 to the remote console 600, during the a long time processing which needs not human operation, for example, installation of software, etc.

The USB HID emulator 200 or the USB storage mirror 300 illustrated in FIG. 1 can be implemented by a software component on a mobile device if the mobile device is used as the assistant device 500, and if the mobile device has a USB controller, a customizable firmware in USB handler section to handle host request during USB device enumeration and data transfers, and an API in the mobile operation system to customize the firmware. A USB cable provided by the vendor of the mobile device connects USB port 160 of USB host, i.e., the controlled computer 100, to USB mini-port, or private port of vendor on the mobile device.

Software USB HID emulator on a mobile device describes itself as a USB human interface device during enumeration by responding to USB host request, including GET_DESCRIPTOR, SET_ADDRESS, SET_CONFIGURATION, and SET_IDLE, by the handler in customized firmware of the mobile device.

Software USB HID emulator on a mobile device reports key stokes, or mouse movements by responding to IN interrupt of USB host, i.e., the controlled computer 100, with 4 bytes data by the customized firmware of the mobile device when the communication manager 260 receives a remote operation of keyboard or mouse.

Software USB storage mirror on a mobile device describes itself as a USB mass storage device by responding to USB host request, including GET_DESCRIPTOR, SET_ADDRESS, and SET_CONFIGURATION, by the handler in customized firmware of the mobile device.

Software USB storage mirror on a mobile device relies data to USB host, i.e., the controlled computer 100, and a Command Status Wrapper (CSW) after the end of the data, when the communication manager 260 receives the data from the remote console 600 in a bulk-only transport.

The standalone USB webcam 410 which is attached to a desktop which is employed as the assistant device 500 can be replaced, by a webcam embedded on another mobile phone, a smart phone, a personal digital assistant, or a laptop, etc., other than the assistant device 500. When an embedded webcam is used, the captured image of display screen 110 of the controlled computer 100 is sent to the assistant device 500 either by wired cable, or by wireless communication, for example, Bluetooth, WIFI, etc., with the co-operation of an agent installed on the device where the embedded webcam resides in.

Similarly, the standalone USB Bluetooth dongle which is used as the short range wireless transceiver 520 can be replaced by the Bluetooth module embedded on a mobile phone, a smart phone, a personal digital assistant, or a laptop which connects to the assistant device 500 by a wired cable. Again, an agent needs to be installed on the device where the embedded short range wireless transceiver resides in, if the device is not the assistant device 500.

An user can request remote, out-of-band management by the exemplary embodiment of the present invention without the USB HID emulator 200, but leveraging a receiver of a Bluetooth wireless keyboard or mouse which is already on the hand of the user, if the Bluetooth wireless keyboard or mouse follows a public specification which defines the communication between the Bluetooth wireless keyboard or mouse and the receiver, or, if the vendor of the Bluetooth wireless keyboard or mouse provides a private API to report keyboard or mouse event on a Personal Computer (PC) or a mobile device by Bluetooth transmitter.

In the exemplary embodiment of present invention, preferably, the assistant device 500 shall not contain any confidential data, or key utilities, and be reset to factory mode or recover to a clean snapshot of operation system before and after the session of remote assistance, to lower the risk of the damage or disclosure of confidential data of the controlled computer 100, caused by the assistant device 500 which is infected by Trojans or backdoor, and is controlled by malicious hacker during remote assistance.

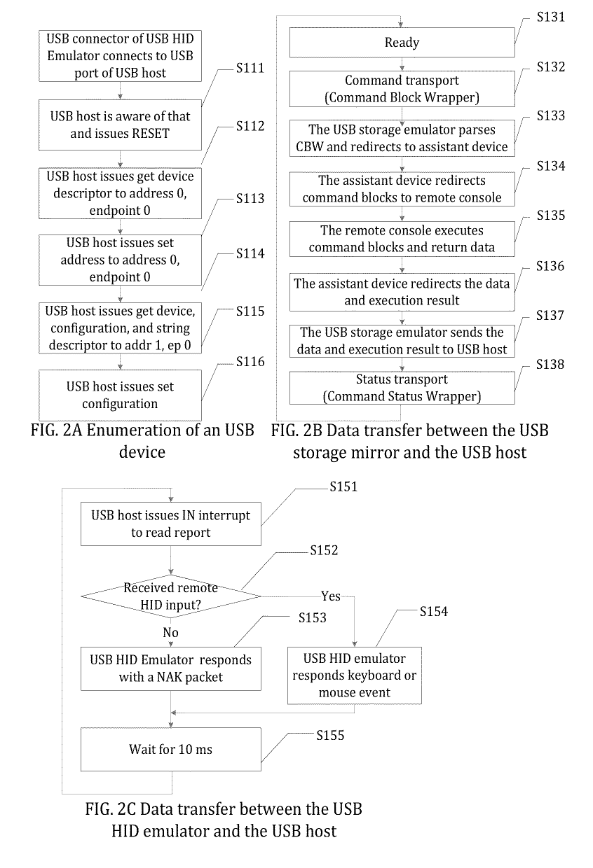

FIG. 2A is a flowchart illustrating enumeration phase of the USB device. FIG. 2A applies to both the hardware or software embodiment of USB HID emulator and the hardware or software embodiment of USB storage mirror.

When USB connector of the USB device is connected to USB port 160 of the USB host, i.e., the controlled computer 100, the USB host becomes aware that a device has been plugged in, because of the pull-up resistor on one data line, and issues a RESET (S111-S112).

The USB host will now send a request to endpoint 0 of device address 0 to find out its maximum packet size by using the Get Descriptor (Device) command (S113).

The USB host sends a Set Address request, with a unique address to the USB device at address 0 (S114).

The USB host begins to quiz the USB device for as many details as the USB host feels it needs. Some requests involved here are: Get Device Descriptor, Get Configuration Descriptor, and Get String Descriptor (S115).

At the moment the USB device is in an addressed but un-configured state, and is only allowed to respond to standard requests.

Once the USB host has a clear enough picture of what the USB device is, the USB host will load a suitable device driver.

The device driver will then select a configuration for the device, by sending a Set Configuration request to the USB device (S116), and from that point in time, the USB device is ‘configured’ and is able to perform its purpose in life. If the USB device is a hardware or software USB HID emulator, the USB host sends the HID class request ‘Set Idle’ (S116), to tell the USB HID emulator only to respond to an interrupt IN transaction if a new event occurs.

FIG. 2B is a flowchart illustrating a bulk-only transport in data transfer between the USB host, i.e., the controlled computer 100, and the USB storage mirror 300.

When the USB storage mirror 300 has been configured and in ready status, the USB host reads the data of Master Boot Record (MBR) at sector 0×0 or mapped files on the USB storage mirror 300 by sending a Command Block Wrapper (CBW) with command blocks in bulk-only transport (S130-S131).

The USB storage mirror 300 parses CBW, gets command blocks in the field of CBWCB of CBW, and sends the command blocks to the assistant device 500 by the short range wireless transceiver 360 (S132).

The assistant device 500 receives the command blocks, and redirects the command blocks to the remote console 600 by the network interface 530, over intranet/internet (S133).

The remote console 600 receives the command blocks, adds pre-specified offset, loads the data in the software resources center 630 in the hard disk, and sends the data to the assistant device 500 over intranet/internet (S134).

The assistant device 500 receives the data and redirects the data to the USB storage mirror 300 over short range wireless signals (S315).

The USB storage mirror 300 sends the data to the USB host in the data transfer in bulk-only transport (S316).

The USB storage mirror 300 sends a Command Status Wrapper (CSW) to USB host to indicate the success or failure of the operation in the data transfer in bulk-only transport (S317).

FIG. 2C is a flowchart illustrating interrupt data transfer between the USB host, i.e., the controlled computer 100, and the USB HID emulator 200.

When the USB HID emulator 200 has been configured, the USB host will start an IN interrupt (S150) to read a report at intervals of 10 ms (or less, typically it would be 8 ms with Windows) (S154).

When an IN request reaches the USB HID emulator 200 and if any encoded data which contains remote keyboard or mouse operation is received by communication manager 260 (S151), the USB HID emulator 200 responds with a 4 byte report of keyboard or mouse events (S153), otherwise, the USB HID emulator responds with a NAK (that means, receiving device cannot accept data or transmitting device cannot send data) packet (S152).

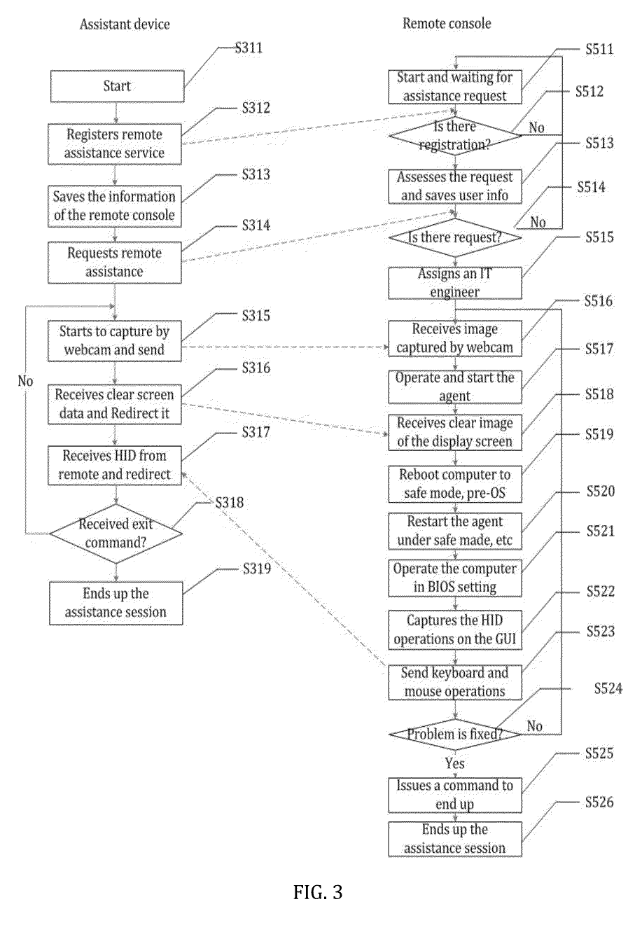

FIG. 3 is a flowchart illustrating the communication between the assistant device 500 and the remote console 600 in an out-of-band management of the controlled computer 100. FIG. 3 does not handle the assessment failure on the remote console 600 and registration request failure and assistance request failure on the assistant device 500 for clear demonstration of the whole picture.

Firstly, on the assistant device 500, agent module registers assistance service to the remote console 600 with unique user identification, for example, a user name or E-mail address, a password and other user information or hardware information of the assistant device 500 over Secure Sockets Layer (SSL), or Transport Layer Security (TLS) (S311-S312 and S511-S512).

On the remote console 600, when there is an assistance service request, a comprehensive assessment is conducted, and then, all of the user information is saved if registration request is accepted (S513).

On the assistant device 500, the information of remote assistance service provider is saved on the assistant device 500 for server authentication or quickly launch, etc., for example, the URL of the server of remote assistance service provider, if registration request is accepted (S313). On the assistant device 500, the user issues the assistance request by operating on the GUI of the agent module 540 with the user identification, password and a description of the problem over SSL, or TLS (S314).

On the remote console 600, the assistance manager 670 authenticates the request by comparing the user identification and password within request with that cached on the remote console 600. If the request is valid, assistance manager assigns an IT engineer who has the knowledge in the field of information technology which matches the problem described in user request (S514-S515).

On the assistant device 500, the agent module 540 controls the webcam, captures the image of display screen 110 of the controlled computer 100. The captured image is compressed, encrypted, and sent to the remote console 600 (S315).

On the remote console 600, the screen image captured by webcam is received, extracted, decrypted and displayed on the GUI 650 which is visible to the remote IT engineer 690 (S516).

On the remote console 600, by viewing the webcam captured image of display screen 110 of the controlled computer, remote IT engineer understands the status on the controlled computer 100 and starts the agent 180 to get clear video output (S517).

On the assistant device 500, the agent module 540 receives the compressed and encrypted screen image which is captured programmably and sent by the agent 180 via the USB storage mirror 300, redirects the image to the remote console 600 (S316).

On the remote console 600, the screen image captured programmably is received, extracted, decrypted and displayed on the GUI 650 which is visible to the remote IT engineer 690 (S518)

On the remote console 600, if the IT engineer need to reboot the controlled computer 100 to safe mode for further diagnosis or anti-virus scan, the IT engineer disconnect the USB mirror 300 from the controlled computer 100 and reboot the controlled computer 100 (S519).

On the remote console 600, if the IT engineer need to reboot the controlled computer 100 to a pre-OS environment or a bootable CD/DVD which contains Windows/Linux installation package, the IT engineer specifies a CD/DVD image file, or a disk area to map to the on-site USB storage mirror 300, setup boot sequence in BIOS with webcam captured screen and the reference of the cached image of step by step BIOS configuration and reboot the controlled computer 100 (S519).

On the remote console 600, the remote IT works with webcam captured screen and restart the agent 180 under safe mode or pre-OS environment, for example, WinPE (S520).

On the remote console 600, the remote IT works with webcam captured screen, user provided information, like boot menu, password account, etc, and reference of the cached image of step by step configurations, finishes jobs including Windows Login, BIOS settings, Windows/Linux installation (S521).

On the remote console 600, the input device hook module 640 captures all of keyboard and mouse event if remote IT engineer enables full screen mode of the GUI 650 of the remote console 600; otherwise, only captures keyboard and mouse input associated with the specific GUI 650 which are related to a specific assistance session. The assistance manager 670 collects captured keyboard and mouse event, encodes the keyboard and mouse events and then sends encoded data to the agent module 540 (S522-S523).

On the assistant device 500, when the agent module 540 receives the encoded data which contains keyboard and mouse events, the agent module 540 redirects the encoded data to the USB HID emulator 200 (317).

The controlled computer responds to the keyboard or mouse input of the USB HID emulator 200 with the aid of diagnostic tools and packages mapped by the USB storage mirror 300, the output of display screen 110 of the computer 100 changes, and is captured, compressed, encrypted and sent out by the assistant device 500 continuously (S315-S317).

On the remote console 600, if the problem is already solved, the remote IT engineer issues a command to end up the assistance session (S524-S525).

On the assistant device 500, when the agent module 540 receives the end up command, the agent module 540 closes the session, and optionally, rates the assistant (S318-S319).

On the remote console 600, when the agent module 540 acknowledges the end up command, the remote console 600 also closes the session, and optionally, rates the user (S526).

In the exemplary embodiment of present invention illustrated by FIG. 1, a newly establish internet connection, for example, a 3G connection, which is used to access remote console from assistant device during a remote, out-of-band management session is preferably employed in Small & Medium Business with out-sourced IT, especially when the whole Local Area Network (LAN) where the computer will be controlled resides in is isolated from remote console because of the breakdown of network device, i.e., switch, router, etc., or Internet Service Provider (ISP) server down. For example, the remote assistance can be used in below scenario.

Scenario 1: Several computers within SMB are attacked by virus, scanning the intranet rapidly. As a result, the intranet is flooded by scan packages and all desktops and laptops are un-able to access internet, and un-able to access remote assistance service provider. With an exemplary embodiment of present invention,

1. One of local personnel requests remote assistance by using a laptop as the assistant device, and inserts a USB 3G dongle on the laptop;

2. To find out the root cause of the disaster, the remote IT engineer instructs the local personnel to install out-of-band management facilities onto the computer which runs network management tool in local involvement mode;

3. One of local personnel installs remote assistance facilities onto the computer which runs network management tool by plugging USB connector of the USB device (including HID emulator and storage mirror) into the USB port of the computer, running the agent on the USB storage mirror;

4. Remote IT engineer now can operate the computer with network management tool with clear screen image; remote IT engineer finds out the computers which are infected by virus and sending scan packages by viewing the log of network management tool.

5. To recover the LAN, the remote IT engineer instructs the local personnel to disconnect the infected computer from the intranet, and operate the network management tool to restart the corresponding port of the switch.

6. As instructed by the remote IT engineer, one of the local personnel disconnects the computers which are infected and sending scan packages within intranet.

7. To recover the computers which are already infected by virus, the remote IT engineer instructs the local personnel to install remote assistance facilities on the infected computer in one touch mode one by one;

8. One of local personnel installs remote assistance facilities onto the infected computer by plugging USB connector of USB HID emulator and USB storage mirror into the USB port of the infected computer, placing a USB webcam which is attached to the laptop in the front of the display screen of the infected computer;

9. Remote IT engineer specified a bootable recue image which contains an anti-virus agent, re-boots the infected computer to USB storage mirror which maps to the image with anti-virus agent, as a USB flash device;

10. Remote IT engineer scans the local disk, and cleans the virus;

11. The problem is solved by remote IT engineer with the help of one of local personnel who has very little IT knowledge.

Another example of usage of the exemplary embodiment of present invention illustrated by FIG. 1 is in IT management system in a big enterprise with many branches in many countries. Out-of-band management for a desktop or a laptop in one country can be conducted by an IT engineer in another country with lower salary.

Scenario 2: An enterprise headquarters in USA and has IT centers in china. One day, a desktop in USA office becomes very slow and fails to respond to any keyboard and mouse input. With an exemplary embodiment of present invention,

1. The owner of the desktop calls out-of-band management request to IT center in china, installs remote assistance facilities in one touch mode by plugging USB HID emulator and USB storage mirror disk into the USB port of the desktop which will be controlled, and places a USB webcam attached to an assistance device, for example, his laptop, in front of the display screen of the desktop;

2. An IT engineer located at china issues a command to force a hard power re-cycling by Intel AMT;

3. The desktop reboots, the IT engineer located at china presses F8 to boot the desktop into safe mode, and conducts all kinds of diagnosis through system tools, event viewer, command prompt, registry editor, etc., disable suspicious drivers & service installed by 3rd party software vendor, etc.;

5. The IT engineer reboots the system of the desktop. If the problem is solved, much time is saved to the owner of desktop who otherwise had to ship his desktop to local IT department for re-building;

6. If the problem is still not solved, the IT engineer needs rebuild the system after confirmed by the owner of the desktop;

7. The IT engineer maps a Windows installation image, for example, a Windows XP SP3 to the USB storage mirror, boots the desktop to the USB storage mirror which is configured to be a USB CD/DVD drive.

8. The IT engineer also can maps a Windows PE image which is specially customized with a driver of 1000M network card to the USB storage mirror, reboots the system to the USB storage mirror and deploys a ghost image on a server on IT department onto the desktop via local, wired network interface.

9. The IT engineer configures the desktop after rebooting, including adding user certificate, token file, etc., inputting password of IT admin for confidential settings, etc.;

10. The owner of the desktop may be involved in the assistance session to input the password of his account by a local, physical keyboard;

11. The desktop is recovered and the assistance ends up.

As indicated in above, a system, method, apparatus and computer program product for providing easy to use and set up, high reliable, secure out-of-band management of a remote computer with low cost of facilities is presented in this invention.

The system, method, apparatus and computer program product presented in this invention for providing out-of-band management of a remote computer is highly reliable because:

1. As indicated in FIG. 1, the controlled computer 100 only contains standard configuration, including display screen 110, processor 120, memory 130, USB roothub 140 and USB port 160. As a result, there is no assumption of the type of platform, health of software, network connectivity and the health of the hardware component which has no relation with the sub-components 110-170, for example, a hard disk, or a CD-ROM device, etc., of the computer 100 for a remote, out-of-band management of the computer 100 by the exemplary embodiment of the present invention.

2. Intel AMT, ASP, Wake-on-LAN or wake-on-wireless-LAN is widely supported by latest computer system. And, the steps of waking up and reset the controlled computers 100 are not mandatory steps in an out-of-band management of the controlled computer 100 by the exemplary embodiment of the present invention.

3. With a newly established internet connection on the assistant device, for example, 3G connection, controlled computer 100 can always be operated remotely by keyboard and mouse even when the whole Local Area Network (LAN) where the controlled computer 100 resides in is isolated from remote service provider because of the breakdown of network device, i.e., switch, router, etc., or Internet Service Provider (ISP) sever down.

4. With a USB storage mirror, un-limited software resources at remote console side can be available to the controlled computer 100 as if on a local USB CD/DVD device, or flash device during remote diagnosis and recovery.

The system, method, apparatus and computer program product presented in this invention for providing remote computer assistance with out-of-band management is easy to use and set up because:

1. The steps to set up the facilities in the exemplary embodiment of the present invention to request out-of-band management includes, placing a USB webcam 410 which is attached to the assistant device 500 in the front of the display screen 110 of the controlled computer 100, plugging USB connectors of the USB HID emulator 200 and the USB storage mirror 300 into the USB ports of the controlled computer 100, running the agent module 540 on the assistant device 500. Both of the steps are very easy even to persons with very little knowledge in IT area. And, there is no pre-configuration which needs to be set up on the controlled computer 100.

2. Compared with product for out-of-band remote computer assistance with KVM over IP, for example, Lantronix Spider, the system, method, apparatus and computer program product presented in this invention for providing remote computer assistance is far easy to set up, almost everybody can deploy it with or without the instruction from remote assistant.

The system, method, apparatus and computer program product presented in this invention for providing remote computer assistance with out-of-band management has low cost of facilities because:

1. The facilities in the exemplary embodiment of present invention for providing out-of-band management includes: a hardware USB device contains the USB HID emulator 200 and the USB storage mirror 300, a triangular easel, a USB webcam with adjustable bracket, a USB Bluetooth dongle, or a USB 3G dongle. The hardware USB device containing the USB HID emulator 200 and the USB storage mirror 300 can be implemented by MCS-51 series and Bluetooth or WIFI which is a mature solution with many vendors. The USB webcam, the USB Bluetooth dongle, and the USB 3G dongle can be bought directly on market from various vendors with large scale of production. Compared with out-of-band management by KVM over IP switch and KVM embedded in chipset (Intel VPro), the design and manufacturing of the hardware component of the embodiment of the present invention is mature and modulized designed, thus the cost of the facilities of the embodiment of the present invention is low.

Some of components in the facilities in the exemplary embodiment of present invention illustrated in FIG. 1 for providing out-of-band management, including USB Bluetooth dongle, USB 3G dongle and USB webcam, can be saved when a mobile device, or a laptop is used as the assistant device and there is embedded Bluetooth module, 3G module, or webcam available on the mobile device or laptop.

3. The USB HID emulator of the USB storage mirror can also be saved when a mobile device is used as the assistant device and there are USB controller, customizable firmware in USB handler section and the API to customize the firmware available on the mobile device, or when there is a Bluetooth wireless keyboard or mouse on hand which is implemented to follow a public available specification of communication between the receiver and the Bluetooth wireless keyboard or mouse, or is implemented to provide a private API to report keyboard or mouse event by a Bluetooth wireless transmitter on a PC or a mobile device by the vendor.

The system, method, apparatus and computer program product presented in this invention for providing remote computer assistance with out-of-band management is secure because:

1. In the exemplary embodiment of present invention, computer which needs remote assistance is only imposed by keyboard and mouse control by remote IT engineer of a trusted service provider, is un-necessary to access to intranet/internet itself at all.

2. In the preferred exemplary embodiments of present invention, the agent module 540 which runs on assistant device connects to remote console by port 80, or port 443.

3. Compared with some remote assistance product which uses a specific port and needs configuration of router, or firewall to allow remote assistance traffic, the exemplary embodiment of present invention needs no configuration to network device, and thus eliminates the risk brought by changing the configuration of router, or firewall temporarily or permanently, or by-pass the firewall to access remote console.

4. Compared with some remote assistance product which also uses port 80, or port 443, for example, LogMeIn, in the exemplary embodiment of present invention, the risk of damage or disclosure confidential data on the controlled computer 100 brought by the infected assistant device by visiting the web site which contains malicious software program incautiously on assistant device during remote assistance is lowered to the most extend because computers which need assistance 100 is not infected directly even when assistant device is infected, and in the preferred exemplary embodiment of present invention, assistant device shall not contain any confidential data, or key utilities, and be reset to factory mode or clean image before and after the session of remote assistance.

What is claimed is:

1. A lightweight method for out-of-band management of a computer with operating system but without network comprising:
redirecting the screen shot or output of telnet of a computer which is under out-of-band management to a console on a server remote from the computer over USB port; and
redirecting keyboard and mouse operations of a remote engineer who works on the console of the remote server to the computer over USB port.

2. The method of claim 1, wherein redirecting the screen shot or output of telnet over USB port comprising the steps of:
installing a hardware USB device which describes itself as a USB mass storage device onto the computer; and
capturing screen shot or output of telnet on the computer; and
saving the captured screen shot or output of telnet of the computer to the USB mass storage device in a normal file writing; and
redirecting the data of the file to an assistant device on the USB mass storage device via wireless or wired communications; and
relaying the data of the file to the remote console on the assistant device over internet/intranet; and
parsing the data of the file to get captured screen shot or output of telnet of the computer on remote console; and
displaying the captured screen shot or output of telnet of the computer on a graphic user interface on the remote console.

3. The method of claim 2, wherein the USB mass storage device is a specially design USB hardware device, receives read/write request from the computer over USB port and redirects read/write request to the assistant device via wireless or wired communications.

4. The method of claim 2, wherein the computer comprises an operating system or execution environment to enumerate the USB mass storage device and to run an application to capture screen data or output of telnet.

5. The method of claim 2, wherein the assistant device comprises internet/intranet connection to transmit the captured screen data or output of telnet.

6. The method of claim 1, wherein redirecting keyboard/mouse operations over USB port comprising the steps of:
installing a hardware USB device which describes itself as a USB human interface device onto the computer; and
capturing the keyboard & mouse operations of the remote engineer on the console of the server; and
sending the keyboard or mouse operations to the assistant device over internet/intranet; and
receiving keyboard or mouse operations on the assistant device over internet/intranet; and
redirecting the keyboard or mouse operations to the USB human interface device on the assistant device over wireless or wired communications; and
reporting the keyboard or mouse operations to the computer on the USB human interface device.

7. The method of claim 6, wherein the USB human interface device is a specially design USB hardware device, receives keyboard or mouse operations from the assistant device via wireless or wired communications and report the operations as normal keyboard/mouse operations to the computer.

8. The method of claim 6, wherein the computer comprises an operating system or execution environment to enumerate the USB human interface device.

9. The method of claim 6, wherein the assistant device comprises internet/intranet connection to receive keyboard/mouse operations of the remote engineer.

10. The method of claim 6, wherein redirecting keyboard/mouse operations over USB port further comprises a mouse position correction system, so that the mouse position on the graphic user interface on the remote console is corrected and properly positioned on the computer.

11. A lightweight method for out-of-band management of a computer without operating system and network comprising:
controlling webcam to capture the display screen of the computer on an assistant device; and
sending the webcam captured screen of the computer to a console of a server remote from the computer over internet/intranet on the assistant device; and
displaying the webcam captured screen of the computer on a graphic user interface on the console redirecting keyboard and mouse operations of a remote engineer who works on the console on the remote server to the computer over USB port.

12. The method of claim 11, wherein redirecting keyboard/mouse operations over USB port comprising the steps of:
installing a hardware USB device which describes itself as a USB human interface device onto the computer; and
capturing the keyboard & mouse operations of the remote engineer on the console of the server; and
sending the keyboard or mouse operations to the assistant device over internet/intranet; and
receiving keyboard or mouse operations on the assistant device over internet/intranet; and
redirecting the keyboard or mouse operations to the USB human interface device on the assistant device over wireless or wired communications; and
reporting the keyboard or mouse operations to the computer on USB human interface device.

13. The method of claim 12, wherein the USB human interface device is a specially design USB hardware device, receives keyboard or mouse operations from the assistant device via wireless or wired communications and report the operations as normal keyboard/mouse operations to the computer.

14. The method of claim 12, wherein the computer comprises an operating system or execution environment to enumerate the USB human interface device.

15. The method of claim 12, wherein the assistant device comprises internet/intranet connection to receive keyboard/mouse operations of the remote engineer.

16. The method of claim 12, wherein redirecting keyboard/mouse operations over USB port further comprises a mouse position correction system, so that the mouse position on the graphic user interface on the remote console is corrected and properly positioned on the computer.

17. A lightweight method of accessing remote software resources on a computer without network or operation system comprising the steps of:
specifying software resources to be accessed by the computer on a console of a server remote from the computer; and
installing a hardware USB device which describes itself as a USB mass storage device onto the computer; and
redirecting the read request which is issued by the computer and targets to the USB mass storage device to an assistant device on the USB mass storage over wireless or wired communication; and
relaying the read request to the remote console on the assistant device over internet/intranet; and
reading the data from the specified software resource on the remote console; and
returning the data to the assistant device on the remote console; and
relaying the data to the USB mass storage device on the assistant device; and
replying data to the computer on the USB mass storage device as a normal reply of the read request.

18. The method of claim 17, wherein the USB mass storage device is a specially design USB hardware device, redirects read/write request to the assistant device via wireless or wired communications, instead of serving the request on local storage medium.

19. The method of claim 17, wherein the remote console comprising a method of creating an artificial FAT32 header for navigation when a file, several files, a folder or several folders are specified as the software resource.

20. The method of claim 17, wherein the assistant device reads the data of software resource and returns the data directly if the data is cached or pre-stored on the assistant device.
